(19) United States
(12) Patent Application Publication
(10) Pub. No.: US 2025/0056161 A1
(43) Pub. Date: Feb. 13, 2025

(54) FLUX TRACKED VOICE-COIL SPEAKER

(71) Applicant: Tymphany HK Limited, Hong Kong (HK)

(72) Inventor: Solal BOUCHET, Taipei City (TW)

(21) Appl. No.: 18/496,566

(22) Filed: Oct. 27, 2023

(30) Foreign Application Priority Data
Aug. 10, 2023 (GB) 2312238.5

(51) Int. Cl. H04R 9/02

(52) U.S. Cl. CPC H04R 9/025; H02K 41/0354; H04R 2307/021; H04R 2307/027; H04R 2499/11

(57) ABSTRACT

A loudspeaker includes a voice coil assembly and a diaphragm connected to the voice coil assembly, wherein the voice coil assembly is configured to electromagnetically drive the diaphragm. The voice coil assembly includes a voice coil and a voice coil former upon which the voice coil is wound. The voice coil former is formed at least partially or completely from, or comprises at least a portion comprising, a material having a high permeability property.

### CROSS REFERENCE TO RELATED APPLICATIONS

This application claims priority of Application No. 2312238.5 filed in the United Kingdom on Aug. 10, 2023 under 35 U.S.C. § 119, the entire contents of all of which are hereby incorporated by reference.

### TECHNICAL FIELD

The present invention relates generally to the field of loudspeakers. In particular, the present invention relates to a loudspeaker that contributes to the improvement of sound quality without increasing the size of the loudspeaker and/or the amount of power input.

### BACKGROUND ART

Loudspeakers are designed to convert electrical energy into sound energy, wherein the sound is produced when a vibrating object, typically a diaphragm, creates sound waves in the air. In essence, loudspeakers comprise a diaphragm, a coil of wire, known as the voice coil which is usually connected to a narrower end of the diaphragm, and a permanent magnet. The voice coil is suspended in a gap between the poles of the permanent magnet, the permanent magnet creating a magnetic field within this gap.

When a wire carrying a current is placed in a magnetic field, the wire experiences a force due to the interaction between the magnetic field and the moving charges in the wire. Thus, when a varying electrical signal is applied to the terminals of the voice coil, a force acting on the voice coil is created by the interaction between the magnetic field of the permanent magnet and the magnetic field created due to current moving in the voice coil. The force acting on the voice coil either pushes or pulls the voice coil relative to the permanent magnetic field, depending on the polarity of the applied signal. This, in turn, causes the diaphragm attached to the coil to vibrate back and forth, acting on the air to create sound waves.

In order to improve the strength of the sound waves, the distance, speed, acceleration and strength of the vibrations of the diaphragm should be increased-in the following, this will be described as the “intensity” of the movement. As the diaphragm is driven by the voice coil, the intensity of the movement of the voice coil plays an important role. In order to increase the intensity of the movement of the voice coil, the force acting on the voice coil needs to be increased.

The force acting on a current in a magnetic field is calculated according to the equation:

F=BIL

The force (F) on the wire is proportional to a current through the wire (I) and the length of the conductor in the magnetic field (L), and the magnetic flux density of the field (B). By manipulating each, some or all of these parameters, the magnitude and/or the direction of the force acting on the voice coil will be changed.

Increasing the length (L) of the voice coil is, however, not always desirable: more space will be needed to accommodate the voice coil, which in turn results in an increase of the size of the loudspeaker. Additionally, an increase in the voice coil length can lead to an increase in the length of wire which is needed, which in turn increases the weight, which is not desirable in speakers.

As another option, the current (I) applied to the voice coil could be increased in order to increase the force. The electrical signal is applied from an amplifier and an increased current for the signal may be achieved by applying more power to said amplifier. This increase in current can be costly, however, since more power is required. Additionally, the amplifier is an external entity to the speaker and, therefore, the output from the amplifier typically cannot be adjusted within or by the speaker. This means that the speaker must always operate with a high power amplifier, in order to achieve the desired force. Thus, this option means that the efficiency of the speaker is related to the amplifier, rather than the loudspeaker itself.

Furthermore, it is generally not desirable to increase the current applied to the voice coil, as this may cause excess heating in the vicinity of the voice coil. This excess heating can be especially problematic when the gap between the poles of the magnet structure is kept as small as possible, in order to concentrate the magnetic flux within the gap. This, in turn, could cause expansion of the voice coil and subsequent rubbing of the voice coil against the top plate. Eventually, this excess heating may cause sound distortion and in extreme cases may even lead to destruction of the voice coil.

It is possible to increase the force acting on the voice coil without the need of a high power amplifier or an increase in the size of the loudspeaker. This could be achieved by increasing the value of the magnetic flux density (B) as the density of the magnetic flux density (B) proportionally increases the force exerted on the voice coil. To achieve such an effect, it is desirable to contain the magnetic flux in the vicinity of the voice coil, such that the force exerted on the voice coil is maximised. The traditional way in which the magnetic flux density (B) is increased is to use bigger and/or more powerful magnets. Such magnets are, however, typically more expensive, require more space and can be heavier, which are all undesirable attributes in speaker design.

Patent Document U.S. Pat. No. 6,868,165 B1 shows a conventional loudspeaker assembly that has a magnet structure, a voice coil and a diaphragm which is connected to a voice coil former upon which the voice coil is wound. The voice coil former is formed as a rigid, circular cylinder, which is made of paper, KAPTON®, NOMEX® or aluminium.

The magnet structure in this prior art includes an annular permanent magnet with an annular opening in the middle. A T-shaped pole piece is attached to a bottom surface of the permanent magnet, such that a post of the T-shaped pole piece extends through the annular opening of the permanent magnet. An annular top plate is attached to a top surface of the permanent magnet. The annular top plate having an opening defined therein which is sized to fit about the post of the T-shaped pole piece and define a gap for accommodating the voice coil. A magnetic flux path is formed in this gap between the top plate and post.

In order to increase the overall efficiency of the loudspeaker, the prior art outlines increasing the magnetic flux density by keeping the gap as small as possible, such that the magnetic flux can be concentrated in the vicinity of the voice coil. This does, however, increase the probability of contact between the voice coil with either one of the annular top plate or T-shaped pole piece, which may in turn cause sound distortion. Since precise dimensions of the T-shaped pole piece and the annular top plate in a production process would need to be met, the manufacturing tolerances would need to be high and thus the cost of producing the loudspeaker is increased.

Patent Document U.S. Pat. No. 7,778,436 B2 discloses a loudspeaker comprising a diaphragm and a vibration part having a magnet and two yokes which are positioned apart from the diaphragm by a desired distance. The diaphragm is attached to a voice coil former.

The magnet in this prior art document is a permanent magnet formed from ferrite or neodymium and has a disc shape. The North pole of the magnet contacts the lower surface of the upper yoke and the South pole is attached to the upper surface of the U-shaped lower yoke. The voice coil is fabricated by winding a coil around the voice former, which is made of either copper or aluminium. The voice coil is positioned between the poles of the magnet, wherein when an electric current is applied to the voice coil, the voice coil either pulls or pushes the diaphragm in order to create sound waves.

In this prior art document, the yokes are formed from injection molding of a mixture of iron, tungsten and nickel powder, and sintering of these materials in order to achieve of increase in the magnetic flux density. The yoke can also be formed from tungsten or alloys such as Permalloy, Mo Permalloy, Mumetal and Supermalloy.

As is also known, and in relation to U.S. Pat. No. 7,778,436, the magnetic field (H) and the magnetic flux density (B) are related through the following equation:

B=μH

Here, μ represents the magnetic permeability. It is desirable to have materials with higher magnetic permeability in a magnetic field, since higher permeability materials provide an increase in the magnetic flux passing through them.

As a result of these materials having high magnetic permeability, the magnetic flux coming from the North pole of the U-shaped yoke is concentrated around the voice coil. Consequently, the density of the magnetic flux passing through the voice coil is increased. Accordingly, the force exerted on the voice coil is increased and the movement of the voice coil is augmented. Since the movement of the diaphragm is directly related to the voice coil movement, the quality of the sound is increased. This known method achieves increased magnetic flux density in the vicinity of the voice coil, without increasing the size of the loudspeaker or the magnitude of the applied current.

In these known loudspeakers, however, the use of the above mentioned materials having high permeability when fabricating the yoke increases the overall weight and in particular cost of the loudspeaker. In particular, the alloys Permalloy, Mo Permalloy, Mumetal and Supermalloy cost more than iron, steel or other materials typically used for the production of yokes.

It is, therefore, desirable to produce loudspeakers with improved sound as efficiently, effectively and economically as possible, without increasing the size of the loudspeaker or power consumption.

### SUMMARY

The present invention is made to solve such technical problems as discussed above and provides a loudspeaker comprising a diaphragm connected to a coil assembly, wherein the coil assembly is configured to electromagnetically drive the diaphragm; the coil assembly comprising a voice coil and a voice coil former upon which the voice coil is wound, wherein the voice coil former is formed at least partially, or completely, from a material having a high permeability property. The loudspeaker further comprises a magnet assembly comprising a permanent magnet and at least one pole piece, wherein the magnet assembly is arranged concentrically with the coil assembly and the magnet assembly is configured to provide a gap to accommodate the coil assembly between poles of the magnet assembly.

It is an aspect of the present invention to concentrate the magnetic flux created in the vicinity of the voice coil.

A gap between the voice coil and the magnet is filled with air. In order to increase the magnetic field strength (magnetic flux density) in this gap, such that the density of the magnetic flux passing around the voice coil is increased, a high permeability material is used in a voice former around which the voice coil is wound.

High permeability materials, which are herein defined as having a relative permeability of 10,000 or more and include such materials as: mu-metal, supermalloy, supermumetal, nilomag, sanbold, molybdenum permalloy, permalloy, Mo Permalloy, and Supermalloy, provide a low reluctance path for magnetic flux. As such, within a magnetic circuit, these materials provide a preferred path for the magnetic flux in an enclosed area with respect to air. Thus, materials such as mu-metal or other high permeability materials have the effect of increasing the magnetic field in a gap between the magnet assembly and the voice coil.

Using a material such as mu-metal or another high permeability material, can have the effect of increasing the magnetic flux density in a gap between the magnet assembly and the voice coil, without needing to reduce the size of the gap or increase the cost by using said materials to produce a magnetic assembly. High permeability materials, when present, tend to constrain magnetic flux in preference to other regions. This in turn increases the magnetic flux density in the gap. Thus, the present invention, which relates to the provision of a loudspeaker comprising a mu-metal or other high permeability material voice coil former, can lead to significant increases in the effective sound quality and efficiency of the loudspeaker when compared to similarly sized loudspeakers, largely by concentrating the magnetic field in a crucial point of the loudspeaker.

Thus, the present invention enables improved sound in loudspeakers without having to increase weight/size, and without significant increase in material costs.

### BRIEF DESCRIPTION OF THE DRAWINGS

FIG. 1 is a cross-sectional view illustrating a loudspeaker assembly according to the invention.

FIG. 2 is a cross-sectional view of an example of a loudspeaker assembly according to the present invention.

FIG. 3 illustrates magnetic field lines of the loudspeaker assembly according to the prior art.

FIG. 4 illustrates magnetic field lines of the loudspeaker assembly according to the present invention when the voice coil is at the maximum height.

FIG. 5 illustrates magnetic field lines of the loudspeaker assembly according to the present invention.

FIG. 6 shows a graph illustrating the force factor BL(x) versus displacement (x) of the present invention compared to the prior art.

FIG. 7 shows another embodiment of the present invention.

### DETAILED DESCRIPTION

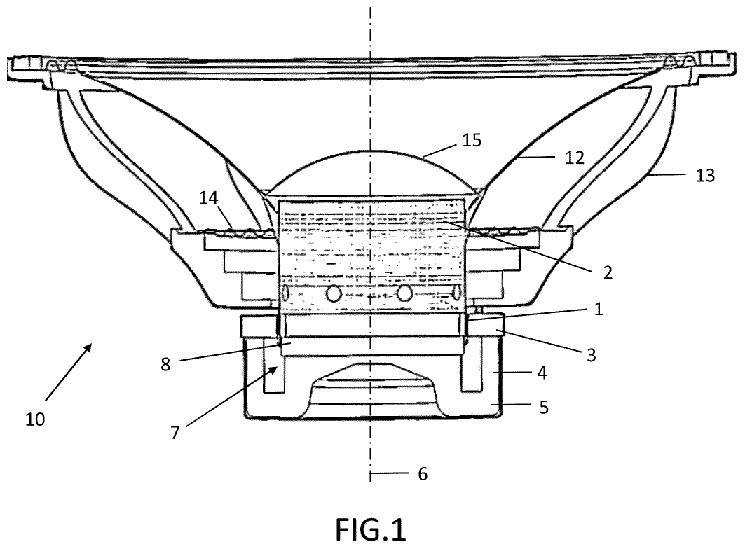

Referring to FIG. 1, a cross-sectional view of a loudspeaker 10 according to a non-limiting embodiment of the present invention is provided. The loudspeaker 10 comprises a frame 13 with a frusto-conical shape and a magnet assembly 3, 4, 5, which is mounted at the smaller end of the frame 13.

The loudspeaker 10 may comprise a diaphragm 12, usually having a membrane element that may generally have the shape of a truncated section of a cone or curved-sided cone, with a dust cap membrane 15 extending across a narrower part of the diaphragm 12. The diaphragm 12 is mounted in the frame 13, such that the wider end of the diaphragm is secured to the wider end of the frame, for example by means of an adhesive, welding or other known techniques.

A cylindrical voice coil former 2 extends from the narrower region of the diaphragm 12 in a direction towards the magnet assembly 3, 4, 5. The outer surface of the voice coil former 2 is concentric around an axis 6. This axis 6 is the central axis of the diaphragm 12, magnet assembly 3, 4, 5 and typically also of the loudspeaker 10.

Preferably, a spider 14 extends from the narrower end of the diaphragm to the inner sides of the frame 13 and is provided to secure the voice coil former 2 with respect to the frame 13. The spider 14 can be formed from a rubber-like material. The spider 14 is connected to the lower portion of the diaphragm 12 and prevents the voice coil former 2 from moving in a direction which is perpendicular to the axis 6.

A voice coil 1, such as a wire, is wound around the outer surface of the coil former 2 and has a pair of lead wires (not shown) that receive electrical signals from an external amplifier. The electrical signal is usually a varying signal and will be translated into sound output. The lead wires of the voice coil 1 are usually, although not always, mounted to the diaphragm 12, for example with glue, such that the lead wires do not interfere with the movement of the voice coil assembly. The voice coil 1 is usually made out of copper, silver or other known and appropriate conductors.

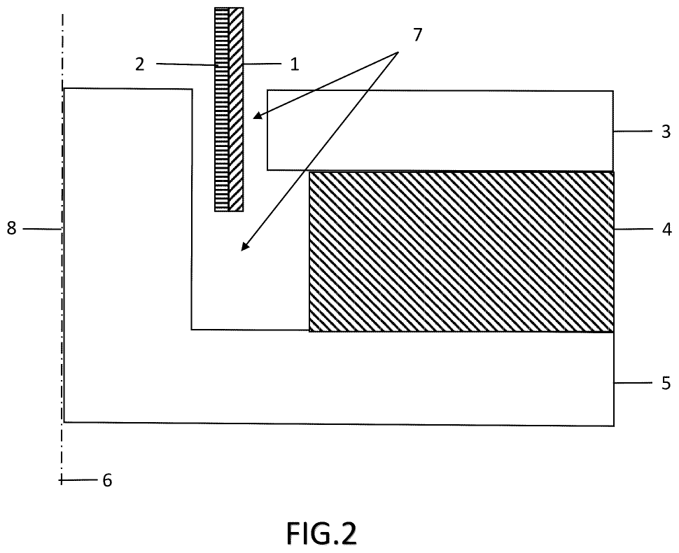

A magnet assembly 3, 4, 5 and the voice coil assembly is depicted in FIG. 2. The magnet assembly 3, 4, 5 has typically, an annular shaped permanent magnet 4. The permanent magnet 4 might also have a square or rectangular outer shape with a hole in the middle. The permanent magnet 4 is sandwiched between an annular front plate 3 and a back plate 5, which are made of magnetically permeable material, such as iron, steel, ferrous alloy, nickel or cobalt alloy.

The back plate 5, preferably circular in shape, is attached to one annular face of the annular permanent magnet 4 and has an outer diameter that is typically similar, or equal, to the outer diameter of the annular permanent magnet 4. In the present embodiment of FIG. 2, a T-shaped back plate 5 is used, although a U-shaped back plate 5 could be used to achieve the same effect in the present invention.

In the embodiment shown in FIG. 2, the back plate 5 has an extending pole piece 8, thus forming a T-piece. The extending pole piece 8 is an element of the back plate 5 extending generally towards the diaphragm 12 in a direction along the central axis 6 of the magnet assembly. The end of the extending pole piece 8, furthest away from the back plate 5, is positioned adjacent to the inner annular face of the top plate 3. A radial gap 7 is thus formed between the outer surface of the pole piece 8 and the inner annular face of the top plate 3 as well as the cylindrical inner surface of the annular magnet 4.

The top plate 3 is mounted to the other face of the annular permanent magnet 4 from the back plate 5. The top plate 3 has an annular form with an outer diameter that is typically similar to that of the back plate 5 and an inside diameter, which is usually smaller than the inner diameter of the annular permanent magnet 4. The annular permanent magnet 4, the back plate 5, and the top plate 3 are preferably concentrically positioned about the axis 6. The top plate 3 and back plate 5 are bonded, or otherwise fixed, to the upper and lower surfaces of the magnet 4, cither by welding or gluing with an adhesive. When the top plate 3 and back plate 5 are fixed to annular magnet 4, they combine to form a magnetic flux path which passes through the radial gap 7.

The voice coil assembly of the loudspeaker 10 is positioned in the radial gap 7 defined by the inner surface of the top plate 3 and the outer surface of the extending pole piece 8. Preferably, the top plate 3 and the back plate 5 are made of ferromagnetic material such as nickel or iron. The radial gap 7 is sized to accommodate the voice coil 1 and the lower end of the voice coil former 2.

The voice coil assembly comprises the voice coil 1 wound on the voice coil former 2. When an electrical signal is applied across the terminals of the voice coil 1, a current moving through the turns of the voice coil 1 produces a varying magnetic field. The magnetic field generated by the voice coil 1 interacts with the magnetic field of the magnet assembly 3, 4, 5. This interaction creates a force on the voice coil assembly and moves the voice coil assembly, generally in a direction parallel with the axis 6. The direction of this movement is determined by the polarity of the applied electrical signal. Since the voice coil assembly is attached to the diaphragm 12, the diaphragm 12 moves along with the voice coil former 2 either towards the magnet assembly 3, 4, 5, or away from the magnet assembly 3, 4, 5. The resulting back-and-forth motion causes the diaphragm 12 to vibrate and drives the air in front of the diaphragm 12, resulting in pressure differentials that travel away as sound waves.

It is desirable that the radial gap 7 be as small as possible such that the magnetic force exerted on the voice coil is maximized without interfering with the free movement of the voice coil 1. As such, a clearance between the extending pole piece 8 and the front plate 3 is maintained between 0.2 mm to 1 mm, preferably between 0.2 mm to 0.6 mm. Clearance between the moving voice-coil 1 and the top plate 3, as well as between the former 2 and the pole piece 8 is maintained between 0.05 mm and 0.75 mm, preferably between 0.15 mm and 0.5 mm, depending on the type of the driver and its intended use.

The density of magnetic flux passing through the voice coil 1 has a direct impact on the intensity of the movement of the voice coil 1. This is because the interaction between the magnetic field created by the applied electrical signal to the voice coil 1 and the magnetic field of the magnetic assembly, cause movement of the voice coil. In order to maximise the force exerted on the voice coil 1, it is desirable to concentrate the magnetic flux within the radial gap 7.

The radial gap 7 is typically filled with the ambient atmosphere in which the loudspeaker 10 is being used, thus meaning that the magnetic flux tends to spread out when traversing the radial gap 7 and is reduced in concentration when compared to the magnetic flux in the top plate 3 and back plate 5. In order to concentrate the magnetic flux within the radial gap 7, crucially without increasing the loudspeaker's size and cost or the power of the applied signal, the present invention uses materials with high permeability to form the voice coil former 2. In the context of the present invention, the high permeability materials are considered as materials with a relative permeability of 10,000 or more.

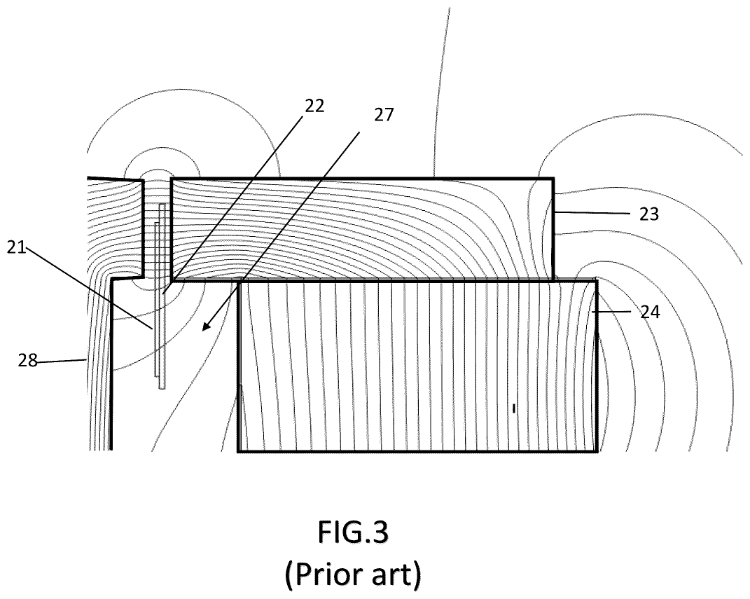

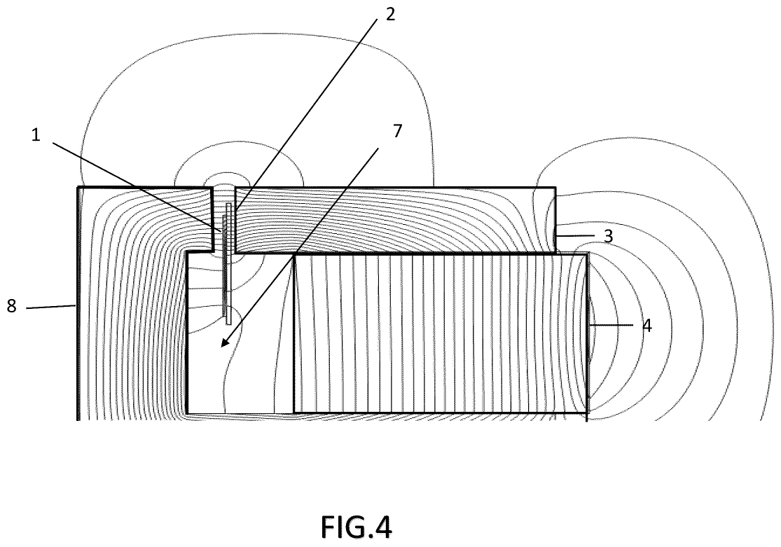

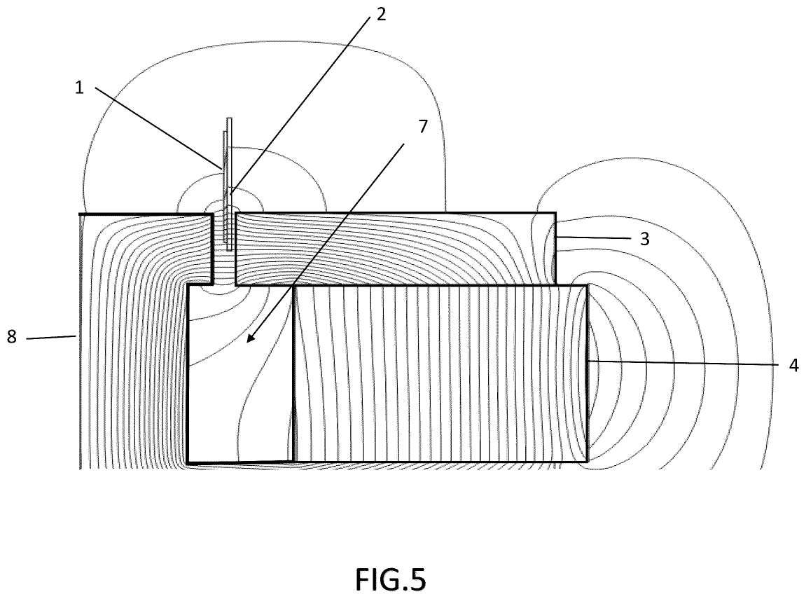

FIG. 3 shows a sectional view of magnetic field lines which represent the magnetic flux created around the magnet assembly 23, 24 and the coil assembly 21, 22 according to a conventional, prior art, loudspeaker. For comparison, FIGS. 4 and 5 show a sectional view of the magnetic field lines of the magnet assembly 3, 4, 5 and the voice coil assembly according to the present embodiment. The magnetic field lines represent the density of the magnetic field and hence the denser magnetic field lines shown in the radial gap 7 of FIGS. 4 and 5, as compared with FIG. 3, show the increased field density which is achieved by the present invention.

In FIG. 3, the magnetic field lines around the voice coil assembly are shown. In this conventional loudspeaker, the voice coil former 22 is made out of paper, KAPTON®, NOMEX®, aluminium or any other standard material. It can be seen that the magnetic field lines within the radial gap 27 are not influenced much, or even at all, by the voice coil former 22 and, thus, are not concentrated around the vicinity of the voice coil 21. The magnetic field formed in the radial gap 27 is generally that which would results from the ambient atmosphere present within the radial gap 27.

In FIGS. 4 and 5, magnetic field lines in the vicinity of the voice coil assembly are more concentrated around the voice coil former 2, when compared with the conventional case. The magnetic field is provided with a preferred path across the radial gap 7 by means of the voice coil former 2 constructed from a high permeability material, such a material being for example mu-metal. As is clear from FIGS. 4 and 5, the magnetic field lines are denser in the region of the radial gap 7 when compared with the conventional loudspeaker shown in FIG. 3. This increase in density of the magnetic field lines indicates a higher magnetic flux.

When the voice coil former 2 is formed of a material having a high permeability, such as mu-metal, the magnetic field lines are more heavily concentrated on the voice coil former 2. Consequently, the density of the magnetic field passing through the voice coil 1 is increased in the invention seen in FIGS. 4 and 5, in particular when compared with the conventional loudspeaker shown in FIG. 3. It can be seen from FIG. 3 that the magnetic field in the radial gap 27 is not modified by any material in the vicinity of the voice coil former 22. Conversely, the magnetic field is more concentrated in the region of the voice coil 1 in FIGS. 4 and 5.

Use of the high permeability material such as mu-metal, supermalloy, supermumetal, nilomag, sanbold, molybdenum permalloy, Mo permalloy, Supermalloy or other similar material, provides a low reluctance path for the magnetic field across the radial gap 7. Thus, using a high permeability material as the voice coil former 2, has the effect of increasing the magnetic field density through, and in the surrounding area of, the voice coil former 2. As a result of increasing the magnetic flux, the force exerted on the voice coil 1 is also increased such that the vibrational intensity of the voice coil 1 is enhanced. Improvement in the performance of the loudspeaker is thus obtained.

The high permeability material is preferably mu-metal, this is a soft magnetic alloy with high magnetic permeability having a higher saturation value when compared with other high permeability materials. Mu-metal has the further advantages of being ductile, malleable and workable, which allows it to be easily formed into thin sheets. In the present embodiment, mu-metal is used to produce the voice coil former 2, since mu-metal has a relative permeability value of 50,000μ/μ₀ which is significantly higher than conventional materials (such as iron, steel, aluminium and paper) used to produce the voice coil formers in conventional loudspeakers.

The magnetic force which is applied onto the voice coil 1, is an important parameter for achieving a high mechanical force causing the diaphragm 12 to move back and forth. Due to the high permeability property of mu-metal, the magnetic field is concentrated on the voice coil former 2 and voice coil 1, hence providing improved flux density of the magnetic field in the radial gap 7. Even when an input signal from the external amplifier is of low power, the magnetic field strength acting on the voice coil 1 will be increased as a result of the voice coil former providing a preferred magnetic flux path, and the movement of the voice coil former 2 and diaphragm 12 will be assured. From the increased magnetic flux density, the movement of the voice coil 1 can still be enough to accurately reproduce the output sound even with a low power input; in this manner, a highly responsive loudspeaker is achieved.

FIG. 5 shows magnetic field lines of the loudspeaker 10 according to the present invention when the voice coil 1 is located above the radial gap 7. It is illustrated that, even when the voice coil is moved further away from and out of the radial gap 7, the magnetic field will still be concentrated on the voice coil 1.

As the voice coil former 2 comprises high permeability materials, the voice coil former 2 provides a low reluctance path for the magnetic field. As such, the voice coil former 2 provides a preferred path for the magnetic field thus improving the magnetic flux density and, thus, when the voice coil former 2 moving the magnetic field moves with the voice coil former 2 and the voice coil 1. In essence, the magnetic field tracks movement of the voice coil assembly and thus the magnetic field around the voice coil 1 is increased.

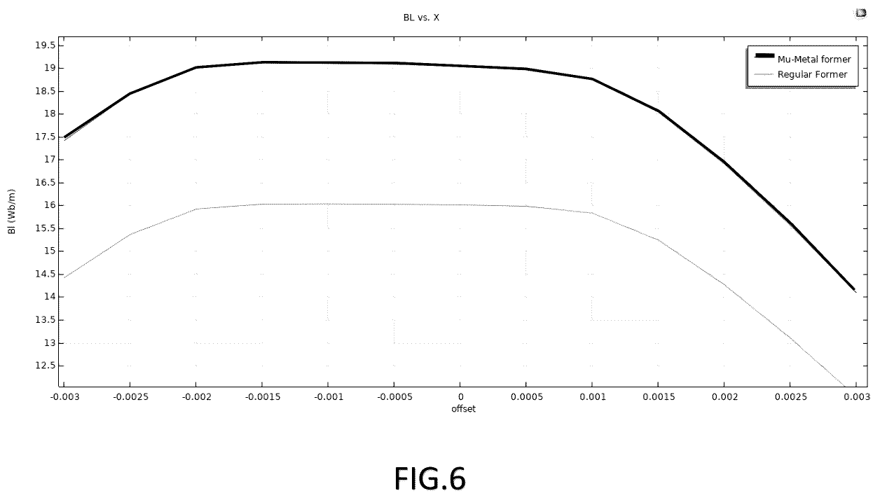

FIG. 6 illustrates the nonlinear force factor characteristic BL(x), which is a function of the voice coil 1 displacement x, of the present invention compared with conventional loudspeakers; in the graph, B is the magnetic flux and L is the length of the voice coil wire. FIG. 6 shows the BL curve when the voice coil 1 moves up and down along the axis 6. The force factor BL(x) is an important factor for the linearity, since it defines the maximum linear excursion the loudspeaker is capable of achieving, where the force=BLI is even. BL(x) is also a determinant factor in the efficiency and sensitivity of the driver. Looking at FIG. 6, the resulting force factor BL(x) of the present invention provides an improvement of around 20% over the force factor measured in a conventional loudspeaker. Thus, the performance of the loudspeaker of the present invention is improved, since the resulting efficiency of the driver is higher.

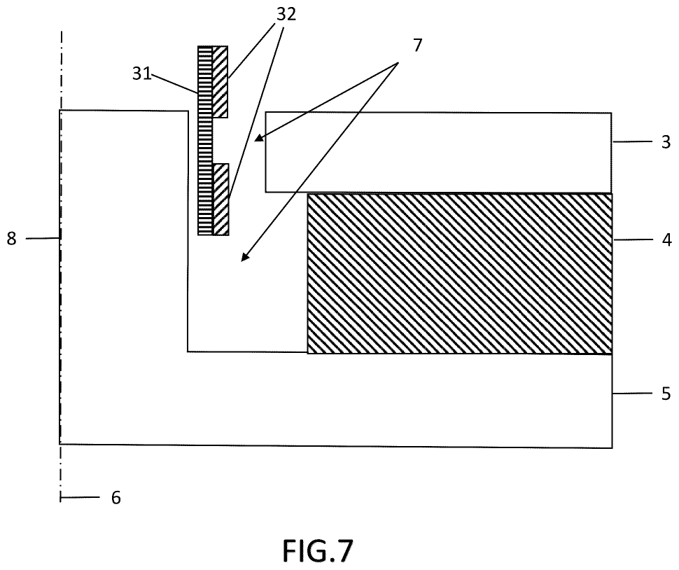

FIG. 7 shows another embodiment according to the present invention. Instead of forming the voice coil former entirely from a high permeability material, preferably mu-metal, collars 32 made out of mu-metal are added to the voice coil former 31. This structure still leads to the improved magnetic field density within the voice coil 1, as the collars 32 focus the magnetic field within the radial gap 7. Providing collars 32 assists in reducing the weight, size and cost of the voice coil former 31 over the embodiment above. In this case, the voice coil former (31) is made from one or more of aluminium, paper, KAPTON®, NOMEX®, or any other suitable material.

By providing a voice coil former 2 composed of a metal with high permeability as in the present invention, a significant improvement in diaphragm vibration and sound quality can be achieved for the same input signal and in comparison to loudspeakers constructed without such high permeability materials in the radial gap 7. In addition, the loudspeakers according to the present invention may be made smaller than conventional designs, yet still produce equivalent sound output. This is further achieved over the cited prior art documents, where mu-metal is used in the magnet assembly, as only using mu-metal in the voice coil former 2 saves weight and costs but still provides the improvement in loudspeaker 10 performance.

1. A loudspeaker comprising:
a voice coil assembly, comprising:
a voice coil; and
a voice coil former upon which the voice coil is wound; and
a diaphragm connected to the voice coil assembly, wherein the voice coil assembly is configured to electromagnetically drive the diaphragm,
wherein the voice coil former is formed at least partially or completely from, or comprises at least a portion comprising, a material having a high permeability property.

2. The loudspeaker according to claim 1, wherein the material is one of mu-metal, supermalloy, supermumetal, nilomag, sanbold, molybdenum permalloy, Mo permalloy and Supermalloy.

3. The loudspeaker according to claim 1, further comprising a magnet assembly comprising:
a permanent magnet; and
at least one pole piece,
wherein the magnet assembly is arranged concentrically with the voice coil assembly, and
wherein the magnet assembly is configured to provide a gap to accommodate the voice coil assembly between poles of the magnet assembly.

4. The loudspeaker according to claim 3, wherein the magnet assembly comprises:
a front plate and a back plate as pole pieces; and
an annular permanent magnet sandwiched between the front plate and the back plate (5),
wherein the back plate and the front plate are concentrically mounted about a central axis of the diaphragm, the magnet assembly and the loudspeaker.

5. The loudspeaker according to claim 4, wherein the front plate and the back plate are magnetically permeable.

6. The loudspeaker according to claim 4, wherein the back plate has an extending piece extending centrally from the back plate and the extending piece has a diameter smaller than the back plate.

7. The loudspeaker according to claim 6, wherein the front plate has an opening sized to fit the extending piece.

8. The loudspeaker according to claim 4, wherein the voice coil assembly is configured to move along the central axis.

9. The loudspeaker according to claim 1, wherein the voice call former formed from a first material, and
wherein one or more collars of high permeability material formed on a surface of the voice call former.

10. The loudspeaker according to claim 9, wherein the voice coil former is made from one or more of aluminium or paper.
